(19) United States
(12) Patent Application Publication
(10) Pub. No.: US 2018/0179438 A1
(43) Pub. Date: Jun. 28, 2018

(54) COATING FOR CONTROLLED RELEASE

(71) Applicant: Dow Global Technologies LLC, Midland, MN (US)

(72) Inventors: Aayush Shah, Houston, TX (US); Arjun Raghuraman, Pearland, TX (US); Stephanie L. Potisek, Houston, TX (US); Juan Carlos Medina, Lake Jackson, TX (US); Larisa Mae Q. Reyes, Lake Jackson, TX (US)

(21) Appl. No.: 15/738,923

(22) PCT Filed: Jun. 23, 2016
(86) PCT No.: PCT/US2016/038972

§ 371 Date: Dec. 21, 2017

Related U.S. Application Data
(60) Provisional application No. 62/186,669, filed on Jun. 30, 2015.
(60) Provisional application No. 62/186,671, filed on Jun. 30, 2015.
(60) Provisional application No. 62/186,645, filed on Jun. 30, 2015.
(60) Provisional application No. 62/287,037, filed on Jan. 26, 2016.
(60) Provisional application No. 62/312,113, filed on Mar. 23, 2016.

(51) Int. Cl. C09K 8/80; C09K 8/52; C09K 8/524

(52) U.S. Cl. CPC C09K 8/805; C09K 2208/32; C09K 8/524; C09K 8/52

(57) ABSTRACT

Embodiments relate to a proppant particle or a solid article that includes a proppant particle/solid article and one or more coatings on an outer surface of the proppant particle/solid article including one or more well treatment agents and one or more controlled release polymer resins. Each well treatment agent is at least one selected from the group of a scale inhibitor, a wax inhibitor, a pour point depressant, asphaltene inhibitor, an asphaltene dispersant, a corrosion inhibitor, a biocide, a viscosity modifier, and a de emulsifier. Each controlled release polymer resin is at least one selected from the group of a polyurethane based resin, an epoxy resin, a phenolic resin, and a furan resin.

### FIELD

Embodiments relate to coatings for articles such as proppants that are enabled for controlled release of additives (e.g., chemical agents such as scale inhibitors), articles such as proppants that have the coatings thereon, methods of making the coatings, and methods of coating the articles such as proppants with the coatings.

### INTRODUCTION

Generally, well fracturing is a process of injecting a fracturing fluid at high pressure into subterranean formations such as subterranean rocks, well holes, etc., so as to force open existing fissures and extract a crude product such as oil or gas therefrom. Proppants are solid material in particulate form for use in well fracturing. Proppants should be strong enough to keep fractures propped open in deep hydrocarbon formations, e.g., during or following an (induced) hydraulic fracturing treatment. Thus, the proppants act as a “propping agent” during well fracturing. The proppants may be introduced into the subterranean formations within the fracturing fluid. The proppants may be coated for providing enhanced properties such as hardness and/or crush resistance. For example, resin coated proppants may impart a degree of adhesion between particles that may reduce the possibility of, minimize, and/or prevents the proppant from being flushed out of the well, a process which may be referred to as flowback. Flowback is undesirable because it may lead to closure of the crack and/or may damage equipment used in the fracturing process. To address issues related to flowback and other issues generally associated with well-fracturing, additives may be introduced into the well.

With respect to additives, it may be desirable to inject one or more well treatment agents within the fracturing fluid and proppant mixture which impart useful chemical properties, e.g., scale inhibition, corrosion inhibition, wax inhibition, and/or pour point depression, to name a few. Often, the process of introducing the additives into the well is complicated and may lead to a substantial amount of time during which the well is not functional, referred to as down time. Further, introduction of such additives may require substantial additional steps to be carried out, e.g., with respect to shipping, storage, and manpower. Accordingly, improvements are sought.

### SUMMARY

Embodiments may be realized by providing a proppant particle or a solid article that includes a proppant particle/solid article and one or more coatings on an outer surface of the proppant particle/solid article including one or more well treatment agents and one or more controlled release polymer resins. Each well treatment agent is at least one selected from the group of a scale inhibitor, a wax inhibitor, a pour point depressant, asphaltene inhibitor, an asphaltene dispersant, a corrosion inhibitor, a biocide, a viscosity modifier, and a de emulsifier. Each controlled release polymer resin is at least one selected from the group of a polyurethane based resin, an epoxy resin, a phenolic resin, and a furan resin.

### BRIEF DESCRIPTION OF THE DRAWINGS

FIG. 1 illustrates exemplary embodiments, including an exemplary embodiment (a) that includes an underlying additive based coating and an overlying polymer resin based coating coated on the underlying additive based coating, and an exemplary embodiment (b) that includes a single coating that is based on both an additive and the polymer resin.

### DETAILED DESCRIPTION

In efforts to minimize, reduce, and/or prevent down time as related to additives usable in well fracturing processes, a resin coated article (e.g., solid article) is proposed that may enable controlled release, during the well fracturing process, of underlying additive(s) and/or embedded additive(s) coated on an article, such as a proppant particle. A potentially high cost process of infusing additives into the pores of highly porous ceramic proppants is taught, e.g., in U.S. Patent Publication No. 2014/026224. However, improved coatings, e.g., in the form of coatings for forming coated proppants, that combine the strength and/or flexibility of a polymer resin based coating (such as at least one selected from the group of a polyurethane resin based coating, an epoxy resin based coating, a phenolic resin based coating, a furan resin based coating, and combinations thereof), which enable controlled release of one or more additives that are more efficiently coated on the article, are proposed. In particular, without intending to be bound by this theory, it is believed that with the combined use of a controlled release polymer resin and an embedded and/or underlying coating that includes one or more additives, the functions of both a resin coating and controlled release of one or more additives may be realized in a cost effective manner for many different types of articles, including highly porous, low porous, and non-porous articles. For example, sand based and ceramic based proppant particles.

Exemplary additives include well treatment agents. In particular, to fracture formations effectively and/or to sustain production over extend periods of time, well treatment agents may be added to fracturing fluid and/or feed down the well. Exemplary well treatment agents may provide benefits in the fracturing phase and/or during the production phase. Exemplary well treatment agents include, e.g., scale inhibitors, wax inhibitors, pour point depressants, asphaltene inhibitors, asphaltene dispersants, corrosion inhibitors, biocides, viscosity modifiers, and de-emulsifiers, which treatment agents may be used in various combinations. Use of well treatment agents with proppants is discussed, e.g., in Application No. PCT/US15/061262. An exemplary method to introduce these additives, such as the well treatment agents, is to premix the agents with fracturing fluid and pump the modified fracturing fluid down the well bore. This method can be costly, as it may require specialized equipment and processes (such as tanks, piping and blending equipment), down time, etc., which adds to capital costs. Also, usage of a large number of treatment agents may lead to issues related to chemical incompatibilities.

The coated article may include one of more coatings that allow for dual function coating that provide the benefit of controlled release of an additive, such as the well treatment agent, and the additional benefit associated with resin coatings on proppants. The one or more coatings may comprise from 0.5 wt % to 10.0 wt % (e.g., 0.5 wt % to 5.0 wt %, 0.5 wt % to 4.0 wt %, 0.5 wt % to 3.5 wt %, etc.) of a total weight of the coating article. In exemplary embodiments, coated articles such as proppants, include an underlying coating formed on a core (e.g., directly on so as to encompass and/or substantially encompass). The core may be a proppant core, such as sand. The underlying coating incorporates/embeds at least one additive such as at least one well treatment agent. Another coating on (e.g., directly on so as to encompass and/or substantially encompass) the underlying coating includes one or more controlled release polymer resins. Each controlled release polymer resin is at least one selected from a polyurethane resin, an epoxy resin, a phenolic resin, and a furan resin (such that the one or more controlled release polymer resins may include one of such resins and/or combinations thereof). In other exemplary embodiments, coated articles include a coating that incorporates/embeds at least one additive such as at least one well treatment agent into a controlled release polymer resin that forms a matrix (i.e., controlled release polymer resin based matrix). Similarly, the controlled release polymer resin based matrix includes has least one of a polyurethane resin, an epoxy resin, a phenolic resin, and a furan resin (such that the controlled release polymer resin may include combinations thereof).

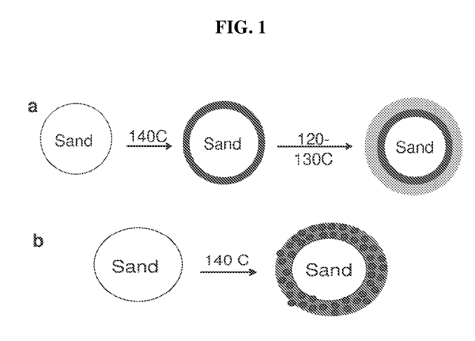

Said in another way, embodiments encompass FIG. 1. Referring to the FIG. 1, embodiment (a) includes an underlying additive based coating (e.g., including at least one well treatment agent) coated on an outer surface of an article such as a proppant sand particle and an overlying polymer resin based coating coated on the underlying additive based coating. Embodiment (b) includes a single coating that is based on both an additive and the polymer resin. In Embodiment (b), the additive may be dispersed in the polymer resin matrix. The additive may be chemically linked to the polymer resin. For embodiment (a), the underlying additive based coating may be directly on an outermost surface of the article (such as proppant particle) and the overlying polymer resin based coating may be directly on the underlying additive based coating, opposing the outermost surface of the article. For embodiment (a), the overlying polymer resin based coating may form an outermost surface of the coated article, with the underlying additive based coating directly under the overlying polymer resin based coating, such that other coatings may be between the outermost surface of the article and the underlying additive based coating. For embodiment (b), the single coating may be directly on an outermost surface of the article (such as proppant particle) and/or may form an outermost surface of the coated article.

The controlled release polymer resin may provide the benefit of being formulated to maintain its properties even when exposed to high temperature, e.g., to temperatures of at least 70° C. The performance of coatings for proppants, especially in down well applications at higher temperatures (such as greater than 120° C.) and elevated pressures (such as in excess of 6000 psig), may be further improved by designing a multilayer coating structure, which may include one layer that may be permeable or semi-permeable and another layer composed of polymer resin matrix that can retain a high storage modulus at high temperatures (such as up to at least 175° C.), which may be typically encountered during hydraulic fracturing of deep strata.

Further, the proppant article may be coated with additional additives, such as additives for recovery and/or removal of other contaminates. The coated proppant may include additional coatings/layers derived from one or more preformed isocyanurate tri-isocyanates and one or more curatives. The different coatings/layers may be sequentially formed and/or may be formed at different times.

The controlled release polymer resin based coating and/or the additive based coating may be formed on a pre-formed polymer resin coated proppant or may be formed immediately after and/or concurrent with forming a polymer resin coating of a proppant. The controlled release additive based coating and/or the additive based coating may be applied to various articles that include the proppant and/or composite applications. Exemplary composite applications include coating the interior of tubes, pipe, and/or pipelines (e.g., that are used in well fracturing and/or waste water management).

Accordingly, embodiments relate to providing a system in which a high percentage of one or more additives such as well treatment agents may be released through a controlled release polymer resin material over an extended period of time. The polymer resin may act as a permeable polymer resin, with respect to the one or more additives. By extended period of time, it is meant at least 2.5 hours (e.g., at least 3.0 hours, at least 100.0 hours, at least 200.0 hours, at least 300.0 hours, etc.). By high percentage, it may be meant that cumulatively at least 50 wt % (e.g., at least 60 wt %, at least 70 wt %, at least 80 wt %, at least 90 wt %, etc.) of the total amount of the additive is released over the extended period of time, such that the controlled release polymer resin does not substantially act to hinder release of the additive and always for delayed release of the additive. By controlled release it is meant that the high percentage of the at least one additive is released over the extended period of time, which extended period of time is longer than if the additive had been coated on the article without use of the controlled release polymer resin. By release it is meant the well treatment agents is released to a surrounding external environment such as fracturing water, so as to move from the coating to the external environment over the extended period of time during which the coated article is exposed to that surrounding external environment.

Said in another way, the controlled release polymer resin may enable delayed released of a majority amount of the one or more additives. For example, at least one additive may be rendered immobile on an outer surface of the proppant particle and/or rendered immobile within the controlled release polymer resin, but as over a period of time the additive may be released/move through the polymer resin coating, so as to be released into the surrounding environment (e.g., into a fracturing fluid).

### Additive Based Coatings

The additive based coating, which may be an underlying coating on (e.g., directly on) an outer surface of an article such as a proppant particle or may be embedded within the controlled release polymer resin coating. The additive based coating includes one or more additives such as one or more well treatment agents. Each well treatment agent is selected from the group of a scale inhibitor, wax inhibitor, a pour point depressant, an asphaltene inhibitor, an asphaltene dispersant, a corrosion inhibitor, a biocide, a viscosity modifier (also can be referred to as a drag reducing agent), and/or a de-emulsifier. The well treatment agents may be used alone or in various combinations. The well treatment agents may be referred to as oil well treatment agents. As would be understood by a person of ordinary skill in the art, a single well treatment agent may provide multiple uses and/or affects, so as to provide overlap between the listed categories.

The well treatment agents are described as follows:
(1) With respect to scale inhibitor, it is meant a chemical additive that acts to reduce the rate of and/or prevent the precipitation and aggregation of slightly insoluble formations on the walls of systems, e.g., systems used in a well fracturing process.
(2) With respect to wax inhibitor, it is meant a chemical additive that acts to reduce the rate of and/or prevent the precipitation out of wax and/or paraffin from a fluid, e.g., the wax and/or paraffin may be a natural compound found in the crude product obtained during a well fracturing process.
(3) With respect to pour point depressant, it is meant a chemical additive that lowers the pour point of a crude product obtained during a well fracturing process, whereas the pour point is the lowest temperature at which the product will pour when cooled under defined conditions and may be indicative of the amount of wax in the product (at low temperatures the wax may separate, inhibiting flow).
(4) With respect to asphaltene inhibitor, it is meant a chemical additive that acts to reduce the rate of and/or prevent the precipitation out of asphaltene (such as destabilized asphaltene), e.g., whereas asphaltene molecules may be found in the crude product obtained during a well fracturing process.
(5) With respect to asphaltene dispersant, it is meant a chemical additive that acts to increase the fluidity of the crude product that includes precipitated asphaltene, e.g., whereas asphaltene molecules may be found in the crude product obtained during a well fracturing process.
(6) With respect to corrosion inhibitor, it is meant a chemical additive that acts to reduce the rate of and/or prevent corrosive effect of acids on metals and/or metal alloy based components used in systems, e.g., systems used in a well fracturing process.
(7) With respect to biocide (also referred to as a disinfectant), it is meant a chemical additive that acts to reduce the rate of and/or prevent the growth of bacteria/microbes in the well, which bacteria may interfere with a process, e.g., a well fracturing process.
(8) With respect to viscosity modifier (also referred to as a viscosity improver), it is meant a chemical additive that is sensitive to temperature, e.g., such that at low temperatures, the molecule chain contracts and does not impact the fluid viscosity and at high temperatures the molecule chain relaxes and an increase in viscosity occurs.
(9) With respect to de-emulsifier (also referred to as emulsion preventors), it is meant a chemical additive that reduces and/or minimizes interfacial tensions within the crude product obtained during a well fracturing process. For example, the de-emulsifier may lower the shear viscosity and the dynamic tension gradient of an oil-water interface in the crude product.

The additive based coating, when a separate underlying layer, may account for less than 10.0 wt %, less than 5.0 wt %, less than 3.0 wt %, less than 2.0 wt %, less than 1.0 wt %, and/or less than 0.5 wt % of a total weight of the coated article such as coated proppant. The additive based coating, when combined with the controlled released polymer resin based coating, may account for less than 10.0 wt %, less than 5.0 wt %, less than 3.0 wt %, less than 2.0 wt %, and/or less than 1.0 wt % of a total weight of the coated article such as coated proppant. The amount of the one or more additives may vary depending on how the well treatment desired is to be performed, the overall thickness of the desired coating, and/or whether the additive based coating and/or controlled released coating are formed as separate layers from any optional undercoat.

When the additive based coating is an underlying coating, the one or more additives may be the majority component of the resultant coating. For example, the one or more additives may account for at least 50 wt %, at least 60 wt %, at least 70 wt %, at least 80 wt %, at least 90 wt %, and/or at least 95 wt % of a total weight of the formulation used to make the underlying coating. The one or more additives may be introduced as a liquid or solid mixture that further includes materials to enhance formation and/or adhesion of the coating on the article. For example, the one or more additives may be introduced with one or more coupling agents, one or more surfactants, and/or one or more adhesion promotors. The underlying layer may exclude any polymer resin based materials, specially the materials used to form the overlying controlled release polymer resin coating so as to form two distinct layers. Alternatively, the underlying layer may include one or more polymer resin based materials that form a matrix, in which the one or more additives may be embedded. The one or more additives, in whole or part, may be introduced within a liquid carrier polymer, such as a water or a polyol.

When the additive based coating is combined with the polymer resin based coating, the one or more additives may account for less than 50 wt %, less than 40 wt %, less than 30 wt %, less than 20 wt %, less than 10 wt %, less than 5 wt %, and/or less than 1 wt % of a total weight of formulation used to make the coating. The one or more additives may be introduced with the polymer resin, introduced with one part of the polymer resin, introduced with one or more components used to form the polymer resin, and/or introduced after the polymer resin, when forming the coating. Polymer resin herein refers to a polyurethane resin, an epoxy resin, a phenolic resin, and/or a furan resin, such that the polymer resin may form a matrix that includes polyurethane resins, epoxy resins, phenolic resins, and/or a furan resins.

Scale inhibitors known in the art may be used. For example, the scale inhibitor may be a polyacrylic acid based salt, which is provided as an aqueous solution or a dried powder. Exemplary scale inhibitors include phosphate, phosphate esters, triethanolamine phosphate esters, phosphonates such as 1-hydroxyethylidene-1,1-diphosphonic acid and diethylene triamine penta (methyl phosphonic acid), polymers such as methacrylic diphosphonate homopolymers, acrylic acid-allyl ethanolamine diphosphonate copolymers, sodium vinyl sulphaste-acrylic acid-maleic acid-diethylene triamine allyl phophonate terpolymers, a salt of acrylamido-methylpropane sulfonate/acrylic acid copolymer, phosphinated acrylic copolymer, polyaspatic acids, polycarboxylates, polyacrylic acids, polymaleic acids, polymethacrylic acids, and/or polyacrylamides. In exemplary embodiments, the scale inhibitor may be a polyacrylic acid sodium salt that is optionally introduced in an aqueous solution.

Wax inhibitors known in the art may be used. Exemplary wax inhibitors include paraffin crystal modifiers and/or dispersants. Exemplary paraffin crystal modifiers include ethylene-vinyl acetate copolymers, styrene maleic anhydride copolymers, olefinic maleic anhydride copolymers, fatty alcohol esters of olefin maleic anhydride copolymers, acrylate copolymers and acrylate polymers of fatty alcohol esters, methacrylate ester copolymers, polyethyleneimines, and/or alkyl phenol-formaldehyde copolymers. Exemplary dispersants include dodecyl benzene sulfonate, oxyalkylated alkylphenols, and oxyalkylated alkylphenolic resins.

Pour point depressants known in the art may be used. Exemplary pour point depressants include thermoplastic homopolymers and/or copolymers. An exemplary thermoplastic polymer is a copolymer of ethylene with at least one vinyl ester of a saturated aliphatic C₁ to C₂₄-carboxylic acid, e.g., see U.S. Pat. No. 3,382,055. In such polymers, different vinyl esters can concurrently be used. The polymers may be prepared by bulk, emulsion, or solution polymerization. As comonomers, e.g., vinyl esters of acetic acid, propionic acid, butyric acid, 2-ethylhexane carboxylic acid, pelargonic acid, and stearic acid, particularly C, to C₄-carboxylic acids, and especially vinyl acetate, may be used.

Asphaltene inhibitors and/or dispersants known in the art may be used. Exemplary asphaltene inhibitors and dispersants include sorbitan monooleate, polyisobutylene succinic anhydride, alkyl succinimides, alkyl phenol-formaldehyde copolymers, polyolefin esters, polyester amides, maleic anhydride functionalized polyolefins, polyamides, polyimides, alkylaryl sulfonic acids, and/or phosphonocarboxylic acids.

Corrosion inhibitors known in the art may be used. The corrosion inhibitors may be referred to acid corrosion inhibitors. The corrosion inhibitors may act to minimize the corrosive effect of the acids found in the fracturing process. For example, the corrosion inhibitor may be a chemical additive used to protect metal components in the wellbore and treating equipment from the corrosive effects of the acid fluids. Exemplary corrosion inhibitors include nitrogen containing compounds, acetylenic containing compounds, thiol/aldehyde containing compounds, quaternary ammonium compounds, “Mannich” condensation compounds, N,n-dimethyl formamide, ammonium bisulfite, and/or cinnamaldehyde.

Biocides known in the art may be used. Exemplary biocides include bromine-based solutions and glutaraldehyde.

Viscosity modifiers known in the art may be used. Exemplary viscosity modifiers include ammonium persulfates, organic peroxides, polymeric viscosifying agents, polyalphaolefins, and/or ethylene propylene diene polymers.

De-emulsifiers known in the art may be used. Exemplary de-emulsifiers include polyols, aromatic resins, alkanolamines, carboxylic acids (such as amino carboxylic acids), bissulfites, hydroxides, sulfates, and/or phosphates.

### Controlled Release Polymer Resin Based Coatings

In embodiments, a coated solid core proppant particle includes at least one controlled release polymer resin based coating, which may be the top coat (outermost coating) forming the coated article such as proppant particle. The controlled released polymer resin based coating includes polyurethane resin, epoxy resin, phenolic resin, and/or furan resin. The coated article such as the proppant particle may optional include additional coats/layers, such as under the controlled release polymer resin based coating. In exemplary embodiments, the controlled release polymer resin coating may include at least additive embedded on and/or within a polymer resin matrix, such as a polyurethane polymer matrix. The one or more additives may be added during a process of forming the controlled release polymer resin based coating and/or may be sprinkled onto a previously coated solid core proppant particle to form the controlled released polymer resin based coating in combination with the additive based coating.

The controlled release polymer resin based coatings may be added as part of an one-component system or a two-component system. For example, the controlled release polymer resin based coating may be used in an one-component polyurethane, phenolic, and/or epoxy system or a two-component polyurethane, phenolic, and/or epoxy systems. For example, the one or more additives may be incorporated into an isocyanate-reactive component for forming the controlled release polymer resin based coating, an isocyanate component (e.g., a polyisocyanate and/or a prepolymer derived from an isocyanate and a prepolymer formation isocyanate-reactive component) for forming the controlled release coating, the prepolymer formation isocyanate-reactive component, and/or a prepolymer derived from an isocyanate and a one component system formation isocyanate-reactive component (such as for a moisture cured one-component polyurethane system).

When separate coatings are formed, a weight ratio the controlled release polymer resin based undercoat to the additive based coating may be from 1:1 to 1:3, such that the weight of the top coat is equal to or greater than the weight of the underlying coat.

Optionally, the one or more additives may be provided in a carrier polymer when forming controlled release polymer resin based coating. Exemplary carrier polymers include simple polyols, polyether polyols, polyester polyols, liquid epoxy resin, liquid acrylic resins, polyacids such as polyacrylic acid, a polystyrene based copolymer resins (exemplary polystyrene based copolymer resins include crosslinked polystyrene-divinylbenzene copolymer resins), Novolac resins made from phenol and formaldehyde (exemplary Novolac resins have a low softening point), and combinations thereof. More than one carrier polyol may be used, e.g., a combination of a liquid epoxy resin with one or more additives therein and a carrier polyol with one or more additives therein may be used. The carrier polyol may be a resin that is crosslinkable so as to provide a permeable or semi-permeable layer on the solid core proppant particle.

Optionally one or more property adjustment additives may be included with the polymer resin or incorporate into the polymer resin (e.g., through a process of forming the polymer resin), e.g., to adjust characteristics of the resultant coating. Additives known to those of ordinary skill in the art may be used. Exemplary additives include moisture scavengers, UV stabilizers, demolding agents, antifoaming agents, blowing agents, adhesion promoters, curatives, pH neutralizers, plasticizers, compatibilizers, flame retardants, flame suppressing agents, smoke suppressing agents, and/or pigments/dyes.

### Polyurethane Resin Based Coating

With respect to the controlled release polymer resin based coating, the polyurethane resin/matrix may be the reaction product of an isocyanate component and an isocyanate-reactive component. As used herein, polyurethane resin encompasses a polyurethane based resin such as a polyurethane/polyisocyanurate resin and polyurethane/epoxy hybrid resin. For the polyurethane resin, the isocyanate component may include at least one polyisocyanate and/or at least one isocyanate-terminated prepolymer and the isocyanate-reactive component may include at least one polyol such as a polyether polyol. For a polyurethane/epoxy hybrid resin, the isocyanate component may include at least one polyisocyanate and/or at least one isocyanate-terminated prepolymer and the isocyanate-reactive component may include at least one epoxy resin containing hydroxyl groups and optionally at least one polyether polyol. Similarly, an optional one or more polyurethane based undercoats (e.g., that includes the one or more additives embedded therewithin), under the controlled release polymer resin based coating, may be the reaction product of a same or a different isocyanate component and a same or a different isocyanate-reactive component.

For example, the optional one or more polyurethane based undercoats may include one or more additives, such that the underlying layer includes a polyurethane resin based matrix. In exemplary embodiments, a single isocyanate component may be used to form both a polyurethane based undercoat and a separately formed polyurethane based matrix. For example, a first isocyanate-reactive component may be added to proppant particles to start the formation of the polyurethane based undercoat, then a first isocyanate component may be added to the resultant mixture to form the polyurethane based undercoat, and then a second isocyanate-reactive component may be added to the resultant mixture to form the controlled released coating. In other exemplary embodiments, one isocyanate-reactive component (e.g., that includes one or more additives and one or more polyols) and one isocyanate component may be used to form the controlled release polyurethane resin based coating and formation of an additional coating thereunder may be excluded.

The polyurethane based matrix may be highly resistant to the conditions encountered in immersion in fracturing fluids at elevated temperatures. For example, the polyurethane based matrix used may be similar to a polyurethane coating discussed in, e.g., U.S. Patent Publication No. 2013/0065800.

The isocyanate-reactive component includes at least a polyol that has a number average molecular weight from 60 g/mol to 6000 g/mol (and optionally additional polyols). The at least one polyol may have on average from 1 to 8 hydroxyl groups per molecule. For forming the polyurethane resin and/or the optional polyurethane based undercoat, the amount of the isocyanate component used relative to the isocyanate-reactive component in the reaction system is expressed as the isocyanate index. The mixture for forming the polyurethane based matrix may have an isocyanate index that is at least 60 (e.g., at least 100). For example, the isocyanate index may be from 60 to 2000 (e.g., 65 to 1000, 65 to 300, 65 to 250, 70 to 200, 100 to 900, 100 to 500, etc.) The isocyanate index is the equivalents of isocyanate groups (i.e., NCO moieties) present, divided by the total equivalents of isocyanate-reactive hydrogen containing groups (i.e., OH moieties) present, multiplied by 100. Considered in another way, the isocyanate index is the ratio of the isocyanate groups over the isocyanate reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

The isocyanate component for forming the polyurethane resin (including a polyurethane/epoxy hybrid based matrix) and/or the polyurethane based undercoat may include one or more polyisocyanates, one or more isocyanate-terminated prepolymer derived from the polyisocyanates, and/or one or more quasi-prepolymers derived from the polyisocyanates. Isocyanate-terminated prepolymers and quasi-prepolymers (mixtures of prepolymers with unreacted polyisocyanate compounds), may be prepared by reacting a stoichiometric excess of a polyisocyanate with at least one polyol. Exemplary polyisocyanates include aromatic, aliphatic, and cycloaliphatic polyisocyanates. According to exemplary embodiments, the isocyanate component may only include aromatic polyisocyanates, prepolymers derived therefrom, and/or quasi-prepolymers derived therefrom, and the isocyanate component may exclude any aliphatic isocyanates and any cycloaliphatic polyisocyanates. The polyisocyanates may have an average isocyanate functionality from 1.9 to 4 (e.g., 2.0 to 3.5, 2.8 to 3.2, etc.). The polyisocyanates may have an average isocyanate equivalent weight from 80 to 160 (e.g., 120 to 150, 125 to 145, etc.) The isocyanate-terminated prepolymer may have a free NCO (isocyanate moiety) of 10 wt % to 35 wt %, 10 wt % to 30 wt %, 10 wt % to 25 wt %, 10 wt % to 20 wt %, 12 wt % to 17 wt %, etc.

Exemplary isocyanates include toluene diisocyanate (TDI) and variations thereof known to one of ordinary skill in the art, and diphenylmethane diisocyanate (MDI) and variations thereof known to one of ordinary skill in the art. Other isocyanates known in the polyurethane art may be used, e.g., known in the art for polyurethane based coatings. Examples, include modified isocyanates, such as derivatives that contain biuret, urea, carbodiimide, allophonate and/or isocyanurate groups may also be used. Exemplary available isocyanate based products include PAPI™ products, ISONATE™ products and VORANATE™ products, VORASTAR™ products, HYPOL™ products, TERAFORCE™ Isocyanates products, available from The Dow Chemical Company.

The isocyanate-reactive component for forming the polyurethane resin (including a polyurethane/epoxy hybrid based matrix) and/or the polyurethane based undercoat includes one or more polyols that are separate from the optional carrier polyol or that include the optional carrier polyol. For example, if the isocyanate-reactive component is added at the same time the one or more additives, the isocyanate-reactive component may include the optional carrier polyol. For example, the isocyanate-reactive component may include a low molecular weight polyether polyol and/or a high molecular weight polyether polyol. With respect to low molecular weight polyether polyol, it is meant a polyether polyol derived from propylene oxide, ethylene oxide, and/or butylene oxide, which has a number average molecular weight from 60 g/mol to less than 800 g/mol (e.g., 60 g/mol to 500 g/mol, 60 g/mol to 300 g/mol, 100 g/mol to 300 g/mol, 200 g/mol to 300 g/mol, etc.) With respect to high molecular weight polyether polyol, it is meant a polyether polyol derived from propylene oxide, ethylene oxide, and/or butylene oxide, which has a number average molecular weight from 800 g/mol to 3000 g/mol (e.g., 800 g/mol to 2500 g/mol, 800 g/mol to 2000 g/mol, 800 g/mol to 1500 g/mol, 900 g/mol to 1200 g/mol, 900 g/mol to 1100 g/mol, etc.) The low molecular weight polyether polyol and the high molecular weight polyether polyol may have a number average hydroxyl functionality from 2 to 4, e.g., may be a triol.

One or more polyols, such as the low molecular weight polyether polyol and the high molecular weight polyol, may be alkoxylates derived from the reaction of propylene oxide, ethylene oxide, and/or butylene oxide with an initiator. Initiators known in the art for use in preparing polyols for forming polyurethane polymers may be used. For example, the one or more polyols may be an alkoxylate of any of the following molecules, e.g., ethylene glycol, diethylene glycol, triethylene glycol, 1,2-propanediol, dipropylene glycol, tripropylene glycol, 1,4-butanediol, 1,6-hexanediol, and glycerol. According to exemplary embodiments, the polyol may be derived from at least propylene oxide and optionally ethylene oxide, of which when present less than 20 wt % (e.g., and greater than 5 wt %) of polyol is derived from ethylene oxide, based on a total weight of the alkoxylate used to for the polyol. According to another exemplary embodiment, the polyol contains terminal ethylene oxide blocks. According to other exemplary embodiments, the polyol may be the initiator themselves as listed above, without any alkylene oxide reacted to it.

In exemplary embodiments, the isocyanate-reactive component may include alkoxylates of ammonia or primary or secondary amine compounds, e.g., as aniline, toluene diamine, ethylene diamine, diethylene triamine, piperazine, and/or aminoethylpiperazine. For example, the isocyanate-reactive component may include polyamines that are known in the art for use in forming polyurethane-polyurea polymers. The isocyanate-reactive component may include one or more polyester polyols having a hydroxyl equivalent weight of at least 500, at least 800, and/or at least 1,000. For example, polyester polyols known in the art for forming polyurethane polymers may be used. The isocyanate-reactive component may include polyols with fillers (filled polyols), e.g., where the hydroxyl equivalent weight is at least 500, at least 800, and/or at least 1,000. The filled polyols may contain one or more copolymer polyols with polymer particles as a filler dispersed within the copolymer polyols. Exemplary filled polyols include styrene/acrylonitrile (SAN) based filled polyols, polyharnstoff dispersion (PHD) filled polyols, and polyisocyanate polyaddition products (PIPA) based filled polyols.

Exemplary available polyol based products include VORANOL™ products, TERAFORCE™ Polyol products, VORAPEL™ products, SPECFLEX™ products, VORALUX™ products, PARALOID™ products, VORARAD™ products, available from The Dow Chemical Company.

The isocyanate-reactive component for forming the polyurethane resin and/or the polyurethane based undercoat may further include a catalyst component that includes one or more catalysts. Catalysts known in the art, such as trimerization catalysts known in art for forming polyisocyanates trimers and/or urethane catalyst known in the art for forming polyurethane polymers and/or coatings may be used. In exemplary embodiments, the catalyst component may be pre-blended with the isocyanate-reactive component. prior to forming a coating.

Exemplary trimerization catalysts include, e.g., amines (such as tertiary amines), alkali metal phenolates, alkali metal alkoxides, alkali metal carboxylates, and quaternary ammonium carboxylate salts. The trimerization catalyst may be present, e.g., in an amount less than 5 wt %, based on the total weight of the isocyanate-reactive component. Exemplary urethane catalyst include various amines, tin containing catalysts (such as tin carboxylates and organotin compounds), tertiary phosphines, various metal chelates, and metal salts of strong acids (such as ferric chloride, stannic chloride, stannous chloride, antimony trichloride, bismuth nitrate, and bismuth chloride). Exemplary tin-containing catalysts include, e.g., stannous octoate, dibutyl tin diacetate, dibutyl tin dilaurate, dibutyl tin dimercaptide, dialkyl tin dialkylmercapto acids, and dibutyl tin oxide. The urethane catalyst, when present, may be present in similar amounts as the trimerization catalyst, e.g., in an amount less than 5 wt %, based on the total weight of the isocyanate-reactive component. The amount of the trimerization catalyst may be greater than the amount of the urethane catalyst. For example, the catalyst component may include an amine based trimerization catalyst and a tin-based urethane catalyst.

### Epoxy Resin Based Coating

With respect to the controlled release polymer resin based coating, the epoxy resin/matrix may be based on epoxy and epoxy hardener chemistry. As used herein, epoxy based coatings encompass the chemistry of an epoxy resin and an amine based epoxy hardener, with an amino hydrogen/epoxy resin stoichiometric ratio range over all possible stoichiometric ratios (e.g., from 0.60 to 3.00, from 0.60 to 2.00, from 0.70 to 2.0, etc.). Further, polyurethane/epoxy hybrid coatings incorporate both epoxy based chemistry and polyurethane based chemistry to form hybrid polymers. As used herein, the term polyurethane encompasses the reaction product of a polyol (e.g., polyether polyol and/or polyester polyol) with an isocyanate index range over all possible isocyanate indices (e.g., from 50 to 1000). Polyurethanes offer various advantages in resin-coated proppant applications, e.g., such as ease of processing, base stability, and/or rapid cure rates that enable short cycle times for forming the coating. For example, polyurethane/epoxy hybrid coatings may be formed by mixing and heating an epoxy resin containing hydroxyl groups, an isocyanate component (such as an isocyanate or an isocyanate-terminated prepolymer, and optionally a polyol component (e.g., may be excluded when an isocyanate-terminated prepolymer is used). Thereafter, an epoxy hardener may be added to the resultant polymer. Liquid epoxy resins known in the art may be used to form such a coating.

For example, for the epoxy resin/matrix, the liquid epoxy resin may be cured by one or more hardener, which may be any conventional hardener for epoxy resins. Conventional hardeners may include, e.g., any amine or mercaptan with at least two epoxy reactive hydrogen atoms per molecule, anhydrides, phenolics. In exemplary embodiments, the hardener is an amine where the nitrogen atoms are linked by divalent hydrocarbon groups that contain at least 2 carbon atoms per subunit, such as aliphatic, cycloaliphatic, or aromatic groups. For example, the polyamines may contain from 2 to 6 amine nitrogen atoms per molecule, from 2 to 8 amine hydrogen atoms per molecule, and/or 2 to 50 carbon atoms. Exemplary polyamines include ethylene diamine, diethylene triamine, triethylene tetramine, tetraethylene pentamine, pentaethylene hexamine, dipropylene triamine, tributylene tetramine, hexamethylene diamine, dihexamethylene triamine, 1,2-propane diamine, 1,3-propane diamine, 1,2-butane diamine, 1,3-butane diamine, 1,4-butane diamine, 1,5-pentane diamine, 1,6-hexane diamine, 2-methyl-1,5-pentanediamine, and 2,5-dimethyl-2,5-hexanediamine; cycloaliphatic polyamines such as, for example, isophoronediamine, 1,3-(bisaminomethyl)cyclohexane, 4,4′-diaminodicyclohexylmethane, 1.2-diaminocyclohexane, 1,4-diamino cyclohexane, isomeric mixtures of bis(4-aminocyclohexyl)methanes. bis(3-methyl-4-aminocyclohexyl)methane (BMACM), 2,2-bis(3-methyl-4-aminocyclohexyl)propane (BMACP), 2,6-bis(aminomethyl)norbornane (BAMN), and mixtures of 1,3-bis(aminomethyl)cyclohexane and 1,4-bis(aminomethyl)cyclohexane (including cis and trans isomers of the 1,3- and 1,4-bis(aminomethyl)cyclohexanes); other aliphatic polyamines, bicyclic amines (e.g., 3-azabicyclo[3.3.1]nonan); bicyclic imines (e.g., 3-azabicyclo[3.3.1]non-2-ene); bicyclic diamines (e.g. 3-azab‘i’cyclo[3.3.1]nonan-2-amine); heterocyclic diamines (e.g., 3,4 diaminofuran and piperazine); polyamines containing amide linkages derived from “dimer acids” (dimerized fatty acids), which are produced by condensing the dimer acids with ammonia and then optionally hydrogenating; adducts of the above amines with epoxy resins, epichlorohydrin, acrylonitrile, acrylic monomers, ethylene oxide, and the like, such as, for example, an adduct of isophoronediamine with a diglycidyl ether of a dihydric phenol, or corresponding adducts with ethylenediamine or m-xylylenediamine; araliphatic polyamines such as, for example, 1,3-bis(aminomethyl)benzene, 4,4′diaminodiphenyl methane and polymethylene polyphenylpolyamine; aromatic polyamines (e.g., 4,4′-methylenedianiline, 1,3-phenylenediamine and 3,5-diethyl-2,4-toluenediamine); amidoamines (e.g., condensates of fatty acids with diethylenetriamine, triethylenetetramine, etc.); polyamides (e.g., condensates of dimer acids with diethylenetriamine, triethylenetetramine; oligo(propylene oxide)diamine; and Mannich bases (e.g., the condensation products of a phenol, formaldehyde, and a polyamine or phenalkamines). Mixtures of more than one diamine and/or polyamine can also be used.

### Phenolic Resin Based Coating

With respect to the controlled release polymer resin based coating, the phenolic resin/matrix may be prepared using curable or pre-cured phenolic materials, such as arylphenol, alkylphenol, alkoxyphenol, and/or aryloxyphenol based phenolic materials. As used herein, phenolic resin encompasses hybrid chemistries, such as phenolic/furan resins, phenolic/polyurethane resins, and phenolic/epoxy resins. The phenolic resin matrix may be formed using one or more curable or pre-cured phenolic thermoset resins. The phenolic thermoset resins may be made by crosslinking phenol-formaldehyde resins with crosslinkers (such as hexamethylenetetramine) Exemplary phenolic resin coatings for proppants are discussed in U.S. Pat. No. 3,929,191, U.S. Pat. No. 5,218,038, U.S. Pat. No. 5,948,734, U.S. Pat. No. 7,624,802, and U.S. Pat. No. 7,135,231.

According to exemplary embodiments, there are two types of phenolic resins that may be used (1) Novolac (phenol to formaldehye ratio is >1), an exemplary structure is shown below where n is an integer of 1 or greater, and (2) Resole (phenol to formaldehye ratio is <1), an exemplary structure is shown below where n is an integer of 1 or greater. Novolac resins may use a crosslinker. Resole resins may not use a crosslinker.

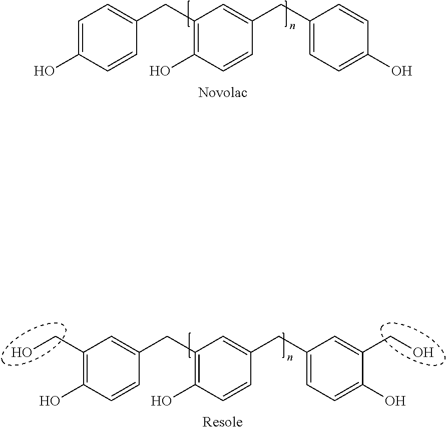

A silane coupling agent may be used, e.g., to generate bond strength, when forming a phenolic resin coating, an exemplary coating is discussed in U.S. Pat. No. 5,218,038. Optionally a lubricant may be added at the end of the process of forming the phenolic resin coating.

For forming an exemplary phenolic resin coating, Novolak resin or alkylphenol-modified novolak resin, or a mixture thereof, is added to the hot sand and mixed. Optionally, one or more additives, such as a silane coupling agent, may be added in a desired amount. Then, to the resultant mixture may be stirred until it has advanced above a desired melt point of the resin (e.g., 35° C. as a minimum). The degree of resin advancing or increasing in molecular weight during the mixing or coating may be important to achieve the desired melt point and resin composition properties. Water may then be added in an amount sufficient to quench the reaction.

### Furan Resin Based Coating

The furan resin based coating may be a furan resin based coating that produces a pre-cured controlled release polymer resin coating. As used herein, furan resin encompasses hybrid chemistries such as furan/phenolic resin, furan/polyurethane resins, and furan/epoxy resins. For example, as discussed in U.S. Pat. No. 4,694,905, particles may be are coated by mixing uncured thermosetting phenolic resin and uncured thermosetting furan resin or a terpolymer of phenol, furfuryl alcohol, and formaldehyde with particulate matter resistant to melting at temperatures below about 450° F. In other examples, the particles may be coated with a furan/furfuryl alcohol resin, furan/formaldehydyde resin, and/or furan/furfuryl/formaldehydyde resin. The formulation for forming the furan resin based coating may utilize a time-delayed catalyst or an external catalyst to help activate the polymerization of the resins if the cure temperature is low, but will cure under the effect of time and temperature if the formation temperature is high. The resultant resin may cure on the particulate matter to produce a free flowing product comprised of individual particles coated with the cured resin.

### Other Coatings

The coated particle may include additional coatings in addition to the additive based coating and the controlled released polymer resin based coating. A total amount of all the optional coatings may be from 0.5 wt % to 4.0 wt % (e.g., 1.0 wt % to 3.5 wt %, 1.5 wt % to 3.0 wt %, 2.0 wt % to 3.0 wt %, etc.), based on the total weight of the coated article such as coated proppant.

For example, under or embedded with the controlled release polymer resin based coating, may be a heavy metal recovery coating such as discussed in priority document, U.S. Provisional Patent Application No. 62/186,645 and/or a sulfide recovery coating such as discussed in priority document, U.S. Provisional Patent Application No. 62/287,037.

In particular, the heavy metal recovery coating may have heavy metal recovery crystals embedded within a polymer resin matrix, which is coated onto a solid core proppant particle. The metal sulfate crystals on the proppant particle may aid in heavy metal recovery by causing heavy metals, such as particles of radioactive radium, to partition onto the coated proppant and away from the contaminated water. The selective post-precipitation of heavy metals such radium ions onto previously formed crystals (e.g., barite crystals) by lattice replacement (lattice defect occupation), adsorption, or other mechanism, is distinctly different from other capture modes such as ion exchange or molecular sieving. For example, the post precipitation of heavy metals such as radium on pre-formed barite crystals is selective for radium because of similar size and electronic structure of radium and barium. In exemplary embodiments, the heavy metal recovery crystals may form a crystalline structure that is appropriately sized to hold the heavy metals such as radium thereon or therewithin. Therefore, the heavy metal recovery crystals may pull the radium out of fracturing fluid and hold the ions on or within the heavy metal recovery coating, so as to reduce radium content in the fracturing fluid.

The sulfide recovery coating may provide a system in which sulfides such as hydrogen sulfide may be removed from contaminated water, e.g., can be absorbed into/onto a matrix and/or may be chemically altered. For example, the sulfide may be chemically altered to form sulfur dioxide. The sulfide capturing agent may be embedded within a polymer resin matrix, which is coated onto a proppant particle, such that optionally the sides of the sulfide capturing agent are encapsulated by the polymer resin. The sulfide capturing agent on the proppant particle may aid in the recovery and/or removal of sulfides from the contaminated water. The sulfide capturing agents (e.g., sulfide capturing crystals) are solids at room temperature (approximately 23° C.). The sulfide capturing crystals may have a melting point greater than 500° C., greater than 800° C., and/or greater than 1000° C. The sulfide capturing agents, such as the sulfide capturing crystals, may have an average particle size of less than 5 μm (e.g., less than 4 μm, less than 2 μm, less than 1 μm, etc.) The polymer resin matrix having the sulfide capturing agent may act as a permeable or semi-permeable polymer resin, with respect to hydrogen sulfide and/or sulfur ions. For example, the hydrogen sulfide and/or sulfur ions may be rendered immobile on an outer surface of the proppant particle and/or rendered immobile within the polymer resin matrix. The polymer resin matrix, polymer coating, and/or the process used to prepare coated proppants may be designed to retain captured sulfide on or within the coatings of the proppants and keep the product in the fracture.

In exemplary embodiments, the sulfide recovery coating may include both the sulfide capturing agent and the heavy metal recovery crystals embedded within a same polymer resin matrix, to form both the sulfide recovery coating and the heavy mental recovery coating.

For example, under or combined with the controlled release polymer resin based coating, may optionally be at least one additional coating/layer derived from one or more preformed isocyanurate tri-isocyanates may be formed, as discussed in U.S. Provisional Patent Application No. 62/140,022. In embodiments, the additional layer is derived from a mixture that includes one or more preformed isocyanurate tri-isocyanates and one or more curatives. The preformed isocyanurate tri-isocyanate may also be referred to herein as an isocyanate trimer and/or isocyanurate trimer. By preformed it is meant that the isocyanurate tri-isocyanate is prepared prior to making a coating that includes the isocyanurate tri-isocyanate there within. Accordingly, the isocyanurate tri-isocyanate is not prepared via in situ trimerization during formation of the coating. In particular, one way of preparing polyisocyanates trimers is by achieving in situ trimerization of isocyanate groups, in the presence of suitable trimerization catalyst, during a process of forming polyurethane polymers. For example, the in situ trimerization may proceed as shown below with respect to Schematic (a), in which a diisocyanate is reacted with a diol (by way of example only) in the presence of both a urethane catalyst and a trimerization (i.e. promotes formation of isocyanurate moieties from isocyanate functional groups) catalyst. The resultant polymer includes both polyurethane polymers and polyisocyanurate polymers, as shown in Schematic (a), below.

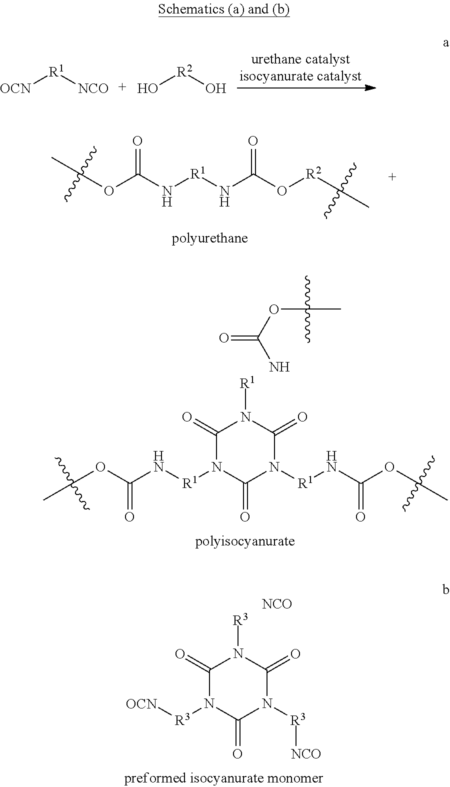

In contrast, referring to Schematic (b) above, in embodiments the preformed isocyanurate tri-isocyanate is provided as a separate preformed isocyanurate-isocyanate component, i.e., is not mainly formed in situ during the process of forming polyurethane polymers. The preformed isocyanurate tri-isocyanate may be provided in a mixture for forming the coating in the form of a monomer, and not in the form of being derivable from a polyisocyanate monomer while forming the coating. For example, the isocyanate trimer may not be formed in the presence of any polyols and/or may be formed in the presence of a sufficiently low amount of polyols such that a polyurethane forming reaction is mainly avoided (as would be understand by a person of ordinary skill in the art). With respect to the preformed isocyanurate tri-isocyanate, it is believed that the existence of isocyanurate rings leads to a higher crosslink density. Further, the higher crosslink density may be coupled with a high decomposition temperature of the isocyanurate rings, which may lead to enhanced temperature resistance. Accordingly, it is proposed to introduce a high level of isocyanurate rings in the coatings for proppants using the preformed isocyanurate tri-isocyanates.

For example, the additional layer may include one or more preformed aliphatic isocyanate based isocyanurate tri-isocyanates, one or more preformed cycloaliphatic isocyanate based isocyanurate tri-isocyanates, or combinations thereof. In exemplary embodiments, the additional layer is derived from at least a preformed cycloaliphatic isocyanate based isocyanurate tri-isocyanate, e.g., the preformed cycloaliphatic isocyanate based isocyanurate tri-isocyanate may be present in an amount from 80 wt % to 100 wt %, based on the total amount of the isocyanurate tri-isocyanates used in forming the additional layer.

Exemplary preformed isocyanurate tri-isocyanates include the isocyanurate tri-isocyanate derivative of 1,6-hexamethylene diisocyanate (HDI) and the isocyanurate tri-isocyanate derivative of isophorone diisocyanate (IPDI). For example, the isocyanurate tri-isocyanates may include an aliphatic isocyanate based isocyanurate tri-isocyanates based on HDI trimer and/or cycloaliphatic isocyanate based isocyanurate tri-isocyanates based on IPDI trimer. Many other aliphatic and cycloaliphatic di-isocyanates that may be used (but not limiting with respect to the scope of the embodiments) are described in, e.g., U.S. Pat. No. 4,937,366. It is understood that in any of these isocyanurate tri-isocyanates, one can also use both aliphatic and cycloaliphatic isocyanates to form an preformed hybrid isocyanurate tri-isocyanate, and that when the term “aliphatic isocyanate based isocyanurate tri-isocyanate” is used, that such a hybrid is also included.

The one or more curatives (i.e., curative agents) may include an amine based curative such as a polyamine and/or an hydroxyl based curative such as a polyol. For example the one or more curatives may include one or more polyols, one or more polyamines, or a combination thereof. Curative known in the art for use in forming coatings may be used. The curative may be added, after first coating the proppant with the preformed aliphatic or cycloaliphatic isocyanurate tri-isocyanate. The curative may act as a curing agent for both the top coat and the undercoat. The curative may also be added, after first coating following the addition of the preformed aliphatic or cycloaliphatic isocyanurate tri-isocyanate in the top coat.

Various optional ingredients may be included in the reaction mixture for forming the controlled release polymer resin based coating, the additive based coating, and/or the above discussed additional coating/layer. For example, reinforcing agents such as fibers and flakes that have an aspect ratio (ratio of largest to smallest orthogonal dimension) of at least 5 may be used. These fibers and flakes may be, e.g., an inorganic material such as glass, mica, other ceramic fibers and flakes, carbon fibers, organic polymer fibers that are non-melting and thermally stable at the temperatures encountered in the end use application. Another optional ingredient is a low aspect ratio particulate filler, that is separate from the proppant. Such a filler may be, e.g., clay, other minerals, or an organic polymer that is non-melting and thermally stable at the temperatures encountered in stages (a) and (b) of the process. Such a particulate filler may have a particle size (as measured by sieving methods) of less than 100 μm. With respect to solvents, the undercoat may be formed using less than 20 wt % of solvents, based on the total weight of the isocyanate-reactive component.

### Proppants

Exemplary proppants (e.g., proppant particles) include silica sand proppants and ceramic based proppants (for instance, aluminum oxide, silicon dioxide, titanium dioxide, zinc oxide, zirconium dioxide, cerium dioxide, manganese dioxide, iron oxide, calcium oxide, and/or bauxite). Various other exemplary proppant material types are mentioned in literature, such as glass beads, walnut hulls, and metal shot in, e.g., Application Publication No. WO 2013/059793, and polymer based proppants as mentioned by U.S. Patent Publication No. 2011/0118155. The sand and/or ceramic proppants may be coated with a resin to, e.g. to improve the proppant mesh effective strength (e.g., by distributing the pressure load more uniformly), to trap pieces of proppant broken under the high downhole pressure (e.g., to reduce the possibility of the broken proppants compromising well productivity), and/or to bond individual particles together when under the intense pressure and temperature of the fracture to minimize proppant flowback. The proppants to be coated may have an average particle size from 50 μm to 3000 μm (e.g., 100 μm to 2000 μm).

Proppant particle (grain or bead) size may be related to proppant performance. Particle size may be measured in mesh size ranges, e.g., defined as a size range in which 90% of the proppant fall within. In exemplary embodiments, the proppant is sand that has a mesh size of 20/40. Lower mesh size numbers correspond to relatively coarser (larger) particle sizes. Coarser proppants may allow higher flow capacity based on higher mesh permeability. However, coarser particles may break down or crush more readily under stress, e.g., based on fewer particle-to-particle contact points able to distribute the load throughout the mesh. Accordingly, coated proppants are proposed to enhance the properties of the proppant particle.

The performance of coatings for proppants, especially in downwell applications at higher temperatures (such as greater than 120° C.) and elevated pressures (such as in excess of 6000 psig), may be further improved by designing coatings that retain a high storage modulus at temperatures of up to at least 175° C., which may be typically encountered during hydraulic fracturing of deep strata. The coating may have a glass transition temperature greater than at least 140° C., e.g., may not realize a glass transition temperature at temperatures below 160° C., below 200° C., below 220° C., below 240° C., and/or below 250° C. The resultant coating may not realize a glass transition temperature within a working temperature range typically encountered during hydraulic fracturing of deep strata. For example, the resultant coating may not realize a glass transition temperature within the upper and lower limits of the range from 25° C. to 250° C. Accordingly, the coating may avoid a soft rubbery phase, even at high temperatures (e.g., near 200° C. and/or near 250° C.). For example, coatings that exhibit a glass transition temperature within the range of temperatures typically encountered during hydraulic fracturing of deep strata, will undergo a transition from a glassy to rubbery state and may separate from the proppant, resulting in failure.

### Coating Process of Proppants

To coat the article such as the proppant, in exemplary embodiments any optional undercoat layer (e.g., a polyurethane based layer) may be formed first. Thereafter, the controlled release polymer resin based coating may be formed on (e.g., directly on) the article/proppant and/or the optional underlying undercoat. In a first stage of forming coated proppants, solid core proppant particles (e.g., which do not have a previously formed resin layer thereon) may be heated to an elevated temperature. For example, the solid core proppant particles may be heated to a temperature from 50° C. to 180° C., e.g., to accelerate crosslinking reactions in the applied coating. The pre-heat temperature of the solid core proppant particles may be less than the coating temperature for the coatings formed thereafter. For example, the coating temperate may be from 40° C. to 170° C. In exemplary embodiments, the coating temperature is at least 85° C. and up to 170° C.

Next, the heated proppant particles may be sequentially blended (e.g., contacted) with the desired components for forming the one or more coatings, in the order desired. For example, the proppant particles may be blended with a formulation that includes one or more additives. Next, the proppant particles may be blended with a first isocyanate-reactive component in a mixer, and subsequently thereafter other components for forming the desired one or more coatings. For an epoxy based matrix, the proppant core particles may be blended with a liquid epoxy resin in the mixer. In exemplary embodiments, a process of forming the one or more coatings may take less than 10 minutes, after the stage of pre-heating the proppant particles and up until right after the stage of stopping the mixer.

The mixer used for the coating process is not restricted. For example, as would be understood by a person of ordinary skill in the art, the mixer may be selected from mixers known in the specific field. For example, a pug mill mixer or an agitation mixer can be used. The mixer may be a drum mixer, a plate-type mixer, a tubular mixer, a trough mixer, or a conical mixer. Mixing may be carried out on a continuous or discontinuous basis. It is also possible to arrange several mixers in series or to coat the proppants in several runs in one mixer. In exemplary mixers it is possible to add components continuously to the heated proppants. For example, isocyanate component and the isocyanate-reactive component may be mixed with the proppant particles in a continuous mixer in one or more steps to make one or more layers of curable coatings.

Any coating formed on the proppants may be applied in more than one layer. For example, the coating process may be repeated as necessary (e.g. 1-5 times, 2-4 times, and/or 2-3 times) to obtain the desired coating thickness. The thicknesses of the respective coatings of the proppant may be adjusted. For example, the coated proppants may be used as having a relatively narrow range of proppant sizes or as a blended having proppants of other sizes and/or types. For example, the blend may include a mix of proppants having differing numbers of coating layers, so as to form a proppant blend having more than one range of size and/or type distribution.

The coated proppants may be treated with surface-active agents or auxiliaries, such as talcum powder or steatite (e.g., to enhance pourability). The coated proppants may be exposed to a post-coating cure separate from the addition of the curative. For example, the post-coating cure may include the coated proppants being baked or heated for a period of time sufficient to substantially react at least substantially all of the available reactive components used to form the coatings. Such a post-coating cure may occur even if additional contact time with a catalyst is used after a first coating layer or between layers. The post-coating cure step may be performed as a baking step at a temperature from 100° C. to 250° C. The post-coating cure may occur for a period of time from 10 minutes to 48 hours.

All parts and percentages are by weight unless otherwise indicated. All molecular weight information is based on number average molecular weight, unless indicated otherwise.

### EXAMPLES

Approximate properties, characters, parameters, etc., are provided below with respect to various working examples, comparative examples, and the materials used in the working and comparative examples.

### Polyurethane Examples

For polyurethane based examples, the materials principally used, and the corresponding approximate properties thereof, are as follows:

| | |
|---|---|
| Sand | Northern White Frac Sand, having a 20/30 mesh |
| | size. |
| Polyol 1 | A low molecular weight polyether polyol |
| | (available as TERAFORCE ™ 0801X Polyol from |
| | The Dow Chemical Company). |
| Polyol 2 | A high molecular weight polyether polyol |
| | (available as VORANOL ™ 8150 Polyol from |
| | The Dow Chemical Company). |
| Polyol 3 | A low molecular weight polyether polyol |
| | (available as VORANOL ™ 270 from The Dow |
| | Chemical Company). |
| Isocyanate 1 | A methylene diphenyl diisocyanate based |
| | trifunctional isocyanate (available as |
| | TERAFORCE ™ 17557 Isocyanate from The |
| | Dow Chemical Company). |
| Prepolymer | An methylene diphenyl diisocyanate based |
| | prepolymer (available as ISONATE ™ 240 from |
| | The Dow Chemical Company). |
| Catalyst 1 | A dibutyltin dilaurate based catalyst that promotes |
| | the urethane or gelling reaction (available as |
| | Dabco ® T-12 from Air Products). |
| Catalyst 2 | A tertiary amine based catalyst that promotes the |
| | polyisocyanurate reaction, i.e., trimerization |
| | (available as Dabco ® TMR from Air Products). |
| Epoxy Resin | A liquid epoxy resin that is a reaction product of |
| | epichlorohydrin and bisphenol A (available as |
| | D.E.R. ™ 383 from The Dow Chemical |
| | Company). |
| Epoxy Hardener | An aliphatic amine based curing agent (available |
| | as D.E.H ™ 518 from The Dow Chemical |
| | Company). |
| Scale Inhibitor | An aqueous solution of polyacrylic acid sodium |
| | salt (available as ACCENT ™ 1100T from The |
| | Dow Chemical Company). The Scale Inhibitor |
| | may be provided in liquid form or may be dried |
| | using a rotary evaporator process to pull out the |
| | liquid, which resultant material is ground down to |
| | form the Solid Scale Inhibitor. |
| Coupling Agent | A silane coupling agent, gamma- |
| | aminopropyltriethoxysilane (for example, |
| | available as Silquest ™ A-1100 from Momentive). |
| Surfactant | A surfactant based on cocamidopropyl |
| | hydroxysultaine (for example, available from |
| | Lubrizol). |

The approximate conditions (e.g., with respect to time and amounts) and properties for forming Working Examples 1 to 4 and Comparative Examples A are discussed below. In particular, Comparative Example A includes only a scale inhibitor based coating. Working Example 1 includes an epoxy based coating on the scale inhibitor based coating. Working Examples 3 to 6 include polyurethane based coatings on the scale inhibitor based coating.

The scale inhibitor based coating is prepared by using a process in which 750 grams of the Sand is heated to a temperature of up to 180° C. in an oven for 45 minutes. Then, the heat Sand is introduced into a KitchenAid® mixer equipped with a heating jacket (configured for a temperature of about 70° C.), to start a mixing process. During the above process, the heating jacket is maintained at 70% maximum voltage (maximum voltage is 120 volts, where the rated power is 425 W and rated voltage is 240V for the heating jacket) and the mixer is set to medium speed (speed setting of 5 on based on settings from 1 to 10). In the mixer, the heated Sand is allowed to attain a temperature of 140° C. Next, the Coupling Agent is added to the Sand in the mixer and mixing is continued for a period of 10 seconds. Then, the Scale Inhibitor is added to the Sand in the mixer and mixing is continued for a period of 20 seconds. Thereafter, for Comparative Example A the mixer is stopped and the coated Sand is emptied onto a tray and allowed to cool at room temperature (approximately 23° C.). For Working Examples 1 to 6, an additional coating is additionally formed on the coated Sand.

For examples that include an epoxy coating, after the stage of adding the Scale Inhibitor, the Epoxy Resin is added to the coated Sand in the mixer to form an additional coating thereon and mixing is continued for a period of 30 seconds. Then, the Epoxy Hardener is added to the coated Sand in the mixer and mixing is continued for a period of 40 seconds. Next, the Surfactant is added to the coated Sand in the mixer and mixing is continued for a period of 20 seconds. Thereafter, the mixer is stopped and the additionally coated Sand is emptied onto a tray and allowed to cool at room temperature (approximately 23° C.).

For examples that include a polyurethane coating with a scale inhibitor dispersed in the polyurethane matrix, 750 grams of the Sand is heated to a temperature of up to 180° C. in an oven for 45 minutes. Then, the heated Sand is introduced into a KitchenAid® mixer equipped with a heating jacket (configured for a temperature of about 70° C.), to start a mixing process. During the above process, the heating jacket is maintained at 70% maximum voltage (maximum voltage is 120 volts, where the rated power is 425 W and rated voltage is 240V for the heating jacket) and the mixer is set to medium speed (speed setting of 5 on based on settings from 1 to 10). In the mixer, the heated Sand is allowed to attain a temperature of 140° C. Next, the Coupling Agent is added to the Sand in the mixer and mixing is continued for a period of 10 seconds. In a separate beaker a Pre-mix that includes the Polyol, Solid Scale Inhibitor, Catalyst 1, and Catalyst 2 are premixed in a FlackTek SpeedMixer™. Then, the Pre-mix is added to the coated Sand in the mixer to form a coating thereon and mixing is continued for a period of 60 seconds. Next, the Isocyanate is added to the coated Sand in the mixer and mixing is continued for a period of 30 seconds before adding the surfactant. Then, the Surfactant is added to the coated Sand in the mixer and mixing is continued for a period of 20 seconds. Thereafter, the mixer is stopped and the additionally coated Sand is emptied onto a tray and allowed to cool at room temperature (approximately 23° C.).

For examples that include an outer polyurethane coating, the coated is formed after the stage of adding the Scale Inhibitor. In particular, in a separate beaker a Pre-mix that includes the Polyol, Catalyst 1, and Catalyst 2 are premixed in a FlackTek SpeedMixer™. Then, the Pre-mix is added to the coated Sand in the mixer to form an additional coating thereon and mixing is continued for a period of 60 seconds. Next, the Isocyanate is added to the coated Sand in the mixer and mixing is continued for a period of 30 seconds before adding the surfactant. Then, the Surfactant is added to the coated Sand in the mixer and mixing is continued for a period of 20 seconds. Thereafter, the mixer is stopped and the additionally coated Sand is emptied onto a tray and allowed to cool at room temperature (approximately 23° C.).

The amounts of the components added are shown below with respect to each individual example.

### Comparative Example A

Coated sand of Comparative Example A has a coated structure that includes 1 wt % of a scale inhibitor coating, the weight percentage being based on the total weight of the coated sand. The respective amount of each component used is shown in Table 1:

TABLE 1

| Component | Weight (grams) |
|---|---|
| Sand | 750.0 |
| Scale Inhibitor | 15.6 |
| Coupling Agent | 0.3 |
| Surfactant | 0.3 |

To evaluate the release of the scale inhibitor from the coating, 50 grams of the resultant sample of Comparative Example is placed in a glass jar and 100 mL of deionized (DI) water is added to the jar. This sample is heated to 94° C. and small aliquots of water suspension are removed at the times indicated below to measure the concentration of the Scale Inhibitor in the water. After each sample is removed, the remainder of the water in the jar is decanted and replaced with fresh DI water. Thus, the concentration measured at each time point is the amount of the Scale Inhibitor released between the sequential time points. Further, the percent released is calculated as the difference between the absolute value of the concentration at Time(n) minus the concentration at Time(n−1), divided by the total amount of scale inhibitor initially added on the sand. This percent is added to percent scale inhibitor released in the previous time point to obtain the cumulative percent scale inhibitor released.

TABLE 2

| | Cumulative Percent Scale |
|---|---|
| Time | Inhibitor Released |
| (hours) | (%) |
| 1.0 | 80 |
| 2.5 | 95 |
| 3.5 | value below measurable limit |
| 20.5 | value below measurable limit |
| 27.5 | value below measurable limit |
| 64.5 | value below measurable limit |
| 166.5 | value below measurable limit |
| 232.5 | value below measurable limit |

Referring to Table 2, the concentration of the Scale Inhibitor in the coating is reduced dramatically within the first hour of submersion in water. Accordingly, controlled release is not observed and it appears the Scale Inhibitor essentially washed off the sample quickly.

### Comparative Example B

Coated sand of Comparative Example B has a coated structure that includes 1.0 wt % of an underlying scale inhibitor coating and 2.0 wt % of an epoxy based coating, weight percentages being based on the total weight of the coated sand. The respective amount of each component used is shown in Table 3:

TABLE 3

| Component | Weight (grams) |
|---|---|
| Sand | 750.0 |
| Scale Inhibitor | 15.6 |
| Coupling Agent | 0.3 |
| Epoxy Resin | 12.7 |
| Epoxy Hardener | 3.4 |
| Surfactant | 0.3 |

To evaluate the release of the scale inhibitor from the coating, 50 grams of the resultant sample of Comparative Example B is placed in a glass jar and 100 mL of deionized (DI) water is added to the jar, similar to as discussed above with respect to Comparative Example A.

TABLE 4

| | Cumulative Percent Scale |
|---|---|
| Time | Inhibitor Released |
| (hours) | (%) |
| 1.0 | 36 |
| 2.5 | 44 |
| 5.0 | value below measurable limit |
| 7.0 | value below measurable limit |
| 71.5 | value below measurable limit |
| 73.5 | value below measurable limit |

Referring to Table 4, the concentration of the Scale Inhibitor in the coating is reduced by less than 50% over a period of approximately 5.0 hours, after which release is not observed for the following 68.5 hours. Therefore, limited controlled release is observed through the epoxy based coating. However, it is believed that the specific epoxy coating inhibited release of at least 50% of the underlying scale inhibitor, as such a highly desired level of controlled release of the Scale Inhibitor from the sample is not observed. Without intended to bound by this theory, the desired level of controlled release through an epoxy resin based coating may be achieved by variations of a formulation.

### Working Example 1

Coated sand of Working Example 1 has a coated structure that includes 0.3 wt % of the scale inhibitor embedded within 2.0 wt % of a polyurethane based coating, weight percentages being based on the total weight of the coated sand. The respective amount of each component used is shown in Table 5:

TABLE 5

| Component | Weight (grams) |
|---|---|
| Sand | 750.0 |
| Scale Inhibitor | 5.9 |
| Coupling Agent | 0.3 |
| Polyol 1 | 3.7 |
| Catalyst 1 | 0.2 |
| Catalyst 2 | 0.3 |
| Isocyanate | 11.3 |
| Surfactant | 0.3 |

To evaluate the release of the scale inhibitor from the coating, 50 grams of the resultant sample of Working Example 1 is placed in a glass jar and 100 mL of deionized (DI) water is added to the jar, similar to as discussed above with respect to Comparative Example A.

TABLE 6

| | Cumulative Percent Scale |
|---|---|
| Time | Inhibitor Released |
| (hours) | (%) |
| 1.0 | 65 |
| 24.0 | 74 |
| 50.0 | 78 |
| 72.0 | 78 |
| 144.0 | 85 |
| 168.0 | 85 |
| 336.0 | 86 |

Referring to Table 6, the concentration of the Scale Inhibitor in the coating is reduced over a period of at least 336 hours, which is an improvement over Comparative Examples A and B. Accordingly, controlled release is observed, as there was delayed release of the Scale Inhibitor from the sample and at least 86% of the total amount of the scale inhibitor is released.

### Working Example 2

Coated sand of Working Example 2 has a coated structure that includes 1.0 wt % of an underlying scale inhibitor coating and 2.0 wt % of a polyurethane based coating, weight percentages being based on the total weight of the coated sand. The respective amount of each component used is shown in Table 7:

TABLE 7

| Component | Weight (grams) |
|---|---|
| Sand | 750.0 |
| Scale Inhibitor | 15.6 |
| Coupling Agent | 0.3 |
| Polyol 1 | 3.7 |
| Catalyst 1 | 0.2 |
| Catalyst 2 | 0.3 |
| Isocyanate | 11.3 |
| Surfactant | 0.3 |

To evaluate the release of the scale inhibitor from the coating, 50 grams of the resultant sample of Working Example 2 is placed in a glass jar and 100 mL of deionized (DI) water is added to the jar, similar to as discussed above with respect to Comparative Example A.

TABLE 8

| | Cumulative Percent Scale |
|---|---|
| Time | Inhibitor Released |
| (hours) | (%) |
| 1.0 | 60 |
| 2.5 | 72 |
| 3.5 | 85 |
| 20.5 | 89 |
| 27.5 | 91 |
| 64.5 | 91 |
| 166.5 | 91 |
| 232.5 | 91.1 |

Referring to Table 8, the concentration of the Scale Inhibitor in the coating is reduced over a period of at least 27.5 hours, which is an improvement over Comparative Examples A and B. Accordingly, controlled release is observed, as there was delayed release of the Scale Inhibitor from the sample and at least 91% of the total amount of the scale inhibitor is released.

### Working Example 3

Coated sand of Working Example 3 has a coated structure that includes 0.4 wt % of an underlying scale inhibitor coating and 0.8 wt % of a polyurethane based coating, weight percentages being based on the total weight of the coated sand. The respective amount of each component used is shown in Table 9:

TABLE 9

| Component | Weight (grams) |
|---|---|
| Sand | 750.0 |
| Scale Inhibitor | 5.9 |
| Coupling Agent | 0.3 |
| Polyol 1 | 1.4 |
| Catalyst 1 | 0.2 |
| Catalyst 2 | 0.1 |
| Isocyanate | 2.5 |
| Surfactant | 0.3 |

To evaluate the release of the scale inhibitor from the coating, 50 grams of the resultant sample of Working Example 3 is placed in a glass jar and 100 mL of deionized (DI) water is added to the jar, similar to as discussed above with respect to Comparative Example A.

TABLE 10

| | Cumulative Percent Scale |
|---|---|
| Time | Inhibitor Released |
| (hours) | (%) |
| 0.1 | 45 |
| 2.5 | 74 |
| 5.0 | 80 |
| 20.5 | 86 |
| 27.5 | 86 |
| 64.5 | 86 |
| 166.5 | 86 |
| 232.5 | 86 |

Referring to Table 10. the concentration of the Scale Inhibitor in the coating is reduced over a period of at least 20.5 hours, which is an improvement over Comparative Example A and B. Accordingly, controlled release is observed, as there was delayed release of the Scale Inhibitor from the sample and at least 86% of the total amount of the scale inhibitor is released.

### Working Example 4

Coated sand of Working Example 4 has a coated structure that includes 1.0 wt % of an underlying scale inhibitor coating and 2.0 wt % of a polyurethane based coating, weight percentages being based on the total weight of the coated sand. The respective amount of each component used is shown in Table 11:

TABLE 11

| Component | Weight (grams) |
|---|---|
| Sand | 750.0 |
| Scale Inhibitor | 15.6 |
| Coupling Agent | 0.3 |
| Polyol 2 | 4.9 |
| Catalyst 1 | 0.2 |
| Catalyst 2 | 0.3 |
| Isocyanate | 10.1 |
| Surfactant | 0.3 |

To evaluate the release of the scale inhibitor from the coating, 50 grams of the resultant sample of Working Example 4 is placed in a glass jar and 100 mL of deionized (DI) water is added to the jar, similar to as discussed above with respect to Comparative Example A.

TABLE 12

| | Cumulative Percent Scale |
|---|---|
| Time | Inhibitor Released |
| (hours) | (%) |
| 1.0 | 70 |
| 26.0 | 85 |
| 30.0 | 89 |
| 48.0 | 90 |
| 72.0 | 90 |
| 144.0 | 90 |
| 312.0 | 90 |

Referring to Table 12, the concentration of the Scale Inhibitor in the coating is reduced over a period of at least 48.0 hours, which is an improvement over Comparative Examples A and B. Accordingly, controlled release is observed, as there was delayed release of the Scale Inhibitor from the sample and at least 90% of the total amount of the scale inhibitor is released.

### Working Examples 5A and 5B

Working Examples 5A and 5B, which are polyurethane based plaques, are prepared to visually observe controlled release of fluorescein dye from the polyurethane based plaques into surrounding water. These plaques are directed toward simulating controlled release of an additive from a polyurethane based coating. The Fluorescein dye is available, e.g., from Sigma-Aldrich. The plaques are prepared using the Polyol 3 and the Prepolymer, which is an isocyanate-terminated prepolymer. To prepare each plaques, the Polyol 3, Fluorescein dye, and Catalyst 1 are mixed in a FlackTek SpeedMixer™. Then, the Prepolymer added to the cup of the FlackTek SpeedMixer™ and mixing is continued for a period of 8 seconds. Next, the resultant mixture is poured into a plate lid mold, maintained at room temperature. The resultant plaque is allowed to cure overnight at room temperature and a section of the plaque is subsequently cut out for experiments. The resultant plaques containing approximately 0.1% of the Fluorescein dye. The respective amounts of components used are shown in Table 13.

TABLE 13

| | Component | Weight (grams) |
|---|---|---|
| Working Example 5A | Polyol 3 | 30.00 |
| | Prepolymer | 24.03 |
| | Fluorescein | 0.05 |
| | Catalyst 1 | 0.18 |
| Working Example 5B | Polyol 3 | 30.00 |
| | Prepolymer | 29.72 |
| | Fluorescein | 0.06 |
| | Catalyst 1 | 0.18 |

To evaluate controlled release of the Fluorescein dye, plaque sections are placed in deionized water at a temperature of 99° C. and samples of the water are periodically removed and visually observed for color over a period of 24 hours. It is found that a yellowish tint of the water samples gradually increased over time for both Working Examples 5A and 5B. Each sample of water is visually evaluated on a comparative Color Scale of 1 to 5, wherein 1 represents the initial clear in appearance of water and 5 represents the darkest yellowish tint observed during the 24 hour period. The subjective results, based on visual inspection of samples of water and relative color change for the samples of water over the period of 24 hours, are summarized in Table 14.

TABLE 14

| | Time (hours) | Color Scale Number |
|---|---|---|
| Working Example 5A | 0 | 1 |
| | 1.0 | 1 |
| | 2.0 | 2 |
| | 3.0 | 3 |
| | 4.5 | 4 |
| | 6.0 | 4 |
| | 24.0 | 5 |
| Working Example 5B | 0 | 1 |
| | 1.0 | 2 |
| | 2.0 | 3 |
| | 3.0 | 3 |
| | 4.5 | 4 |
| | 6.0 | 4 |
| | 24.0 | 5 |

Referring to Table 14, an increase in yellow tint is observed as control release of the Fluorescein dye is, as there was delayed release of the Fluorescein dye from the plaque.

### Static Bottle Testing

Static Bottle Testing is performed for Working Example 4, relative to Comparative Example A (Scale Inhibitor coating only), Comparative Example C (Polyurethane coating prepared similar to Working Example 4 without adding the Scale Inhibitor), and Comparative Example D (uncoated Sand).

Comparative Example C has a coated structure that includes 2.0 wt % of a polyurethane based coating, weight percentages being based on the total weight of the coated sand. The respective amount of each component used is shown in Table 15:

TABLE 15

| Component | Weight (grams) |
|---|---|
| Sand | 750.0 |
| Coupling Agent | 0.3 |
| Polyol 2 | 4.9 |
| Catalyst 1 | 0.2 |
| Catalyst 2 | 0.3 |
| Isocyanate | 10.1 |
| Surfactant | 0.3 |

Static Bottle Testing is performed using the following stages: (1) prepare calcium carbonate based cationic and anionic brines using methods described in laboratory screen test: NACE TM0374; (2) weigh out 10 grams of each sample into respective bottles; (3) add 50 mL anionic brine and swirl/shake the bottle, after which the sample is allowed to sit for approximately 30 minutes to 1 hour; (4) add 50 mL cationic brine to the bottle and place in an oven at 85° C.; (5) after 24 hours, an aliquot is taken from the above bottle, which aliquot is filtered with a 0.45 μm syringe filter, the sample is labelled t=24 hours, and the remainder of the solution is drained out; (6) the sample is then washed with distilled water; (7) add 50 mL anionic brine to the bottle and place in the oven at 85° C., this anionic brine is allowed to stand; (8) after 24 hours, add 50 mL cationic brine to the bottle and place in oven at 85° C.; (9) after another 24 hours, an aliquot is taken from the above bottle, which aliquot is filtered with a 0.45 μm syringe filter, the sample is labelled t=72 hours, and the remainder of the solution is drained out; (10) the sample is then washed with distilled water; (9) add 50 mL anionic brine to the bottle and placed in the oven at 85° C.; (11) allow the anionic brine to stand in sample for 4 days; (12) add 50 mL cationic brine to the bottle and place in the oven at 85° C.; and (13) after 24 hours, an aliquot is taken from the above bottle, which aliquot is filtered with a 0.45 μm syringe filter, the sample is labelled t=1 week, and the remainder of the solution is drained out.

All the aliquots are submitted for ICP analysis. The ICP results measure the concentration of calcium ions in solution. Initial concentration of calcium ions in the brine is 1667 ppm. The percent scale inhibitor is measured using the following formula:

$$\% scale inhibition = \frac{\begin{matrix}[ Ca ions in solution from coated sand ] - \\ [ Ca ions from bare sand ]\end{matrix}}{1667 [ Ca ions from bare sand ]} * 100$$

The results of the ICP

TABLE 16

| | | Concentration of Ca+ ions |
|---|---|---|
| | Time (hours) | in solution |
| Working Example 4 | 24 | 1760 |
| | 72 | 1420 |
| | 168 | 1580 |
| Comparative Example A | 24 | 1765 |
| (scale inhibitor coating only) | 72 | 1315 |
| | 168 | 985 |
| Comparative Example C | 24 | 1655 |
| (polyurethane coating only) | 72 | 1030 |
| | 168 | 1290 |
| Comparative Example D | 24 | 1125 |
| (uncoated sand only) | 72 | 971 |
| | 168 | 1260 |

Table 16 shows the amount of Calcium ions remaining in solution, which is a measure of the effectiveness of the scale inhibitor. The concentration of calcium in solution after 1 week (168 hours) for Working Example 4, [Ca⁺²]=1580, is much higher compared to Comparative Examples A, C, and D. [Ca⁺²]=985, 1290 and 1260. The data suggests that Working Example 5 exhibited delayed release of the inhibitor, therefore, offering scale inhibition over a longer period of time compared to the controls.

1. A coated proppant, comprising:
a proppant particle; and
one or more coatings on an outer surface of the proppant particle including one or more well treatment agents and one or more controlled release polymer resins, each well treatment agent being at least one selected from the group of a scale inhibitor, a wax inhibitor, a pour point depressant, asphaltene inhibitor, an asphaltene dispersant, a corrosion inhibitor, a biocide, a viscosity modifier, and a de emulsifier, and each controlled release polymer resin being at least one selected from the group of a polyurethane based resin, an epoxy resin, a phenolic resin, and a furan resin.

2. The coated proppant as claimed in claim 1, wherein the one or more coatings includes:
an underlying additive based coating that includes the one or more well treatment agents coated on the proppant particle, and
an overlying polymer resin based coating that includes the one or more controlled release polymer resins.

3. The coated proppant as claimed in claim 1, wherein the one or more coatings includes a single coating on the proppant particle, the single coating including the one or more well treatment agents and the one or more controlled.

4. The coated proppant as claimed in claim 1, wherein the one or more coatings account for 0.5 wt % to 5.0 wt % of a total weight of the coated proppant.

5. The coated proppant as claimed in claim 1, wherein the one or more controlled release polymer resins allow for release of at least 50 wt % of a total weight of the one or more well treatment agents coated on the proppant particle over a period of at least 2.5 hours.

6. The coated proppant as claimed in claim 1, wherein at least the one or more controlled release polymer resins form an outermost most coating on the proppant particle.

7. The coated proppant as claimed in claim 1, wherein the one or more well treatment agents includes the scale inhibitor and the one or more controlled release polymer resins includes the polyurethane resin.

8. The coated proppant as claimed in claim 7, wherein the scale inhibitor is a polyacrylic acid based salt.

9. The coated proppant as claimed in claim 7, wherein the polyurethane resin is the reaction product of an isocyanate component and an isocyanate-reactive component, the isocyanate-reactive component including one or more polyether polyols.

10. A coated article, the process comprising:
a solid article; and
one or more coatings on an outer surface of the solid article including one or more well treatment agents and one or more controlled release polymer resins, each well treatment agent being at least one selected from the group of a scale inhibitor, a wax inhibitor, a pour point depressant, asphaltene inhibitor, an asphaltene dispersant, a corrosion inhibitor, a biocide, a viscosity modifier, and a de emulsifier, and each controlled release polymer resin being at least one selected from the group of a polyurethane based resin, an epoxy resin, a phenolic resin, and a furan resin.
